(19) United States
(12) Patent Application Publication
(10) Pub. No.: US 2011/0085047 A1
(43) Pub. Date: Apr. 14, 2011

(54) PHOTOGRAPHING CONTROL METHOD TO SET PHOTOGRAPHING CONFIGURATION ACCORDING TO IMAGE PROCESSING SCHEME USEABLE WITH IMAGE CONTENT, AND PHOTOGRAPHING APPARATUS USING THE SAME

(75) Inventor: Young-jae YOO, Hwaseong-sil (KR)

(73) Assignee: Samsung Electronics Co., Ltd, Suwon-si (KR)

(21) Appl. No.: 12/900,670

(22) Filed: Oct. 8, 2010

(30) Foreign Application Priority Data
Oct. 8, 2009 (KR) 2009-95715

(51) Int. Cl. H04N 5/225; H04N 5/228

(52) U.S. Cl. 348/207.1; 348/222.1; 348/E05.048; 348/E05.024

(57) ABSTRACT

A photographing control method and a photographing apparatus applying the same are provided. The photographing control method includes setting an image photographing configuration according to an image processing scheme useable with image content. Therefore, it is possible to easily set various photographing configurations according to a user's preference.

### CROSS-REFERENCE TO RELATED APPLICATIONS

This application claims priority under 35 U.S.C. §119 (a) of Korean Patent Application No. 2009-95715, filed on Oct. 8, 2009, in the Korean Intellectual Property Office, the disclosure of which is incorporated herein by reference in its entirety.

### BACKGROUND

1. Field of the Invention

The present general inventive concept relates to a photographing apparatus and a photographing control method thereof. More particularly, the present general inventive concept relates to a photographing apparatus to photograph an object for photography to generate image content, and a photographing control method of the photographing apparatus.

2. Description of the Related Art

Photographing configurations in photographing apparatuses such as digital cameras or digital camcorders may be set with many limitations. Accordingly, it is almost impossible for users to set photographing configurations according to their preference.

In addition, to set photographing configurations of a photographing apparatus, a user needs to individually input setting values for each item corresponding to each photographing configuration through a menu screen of the photographing apparatus. However, this input manipulation to set photographing configurations may be very troublesome to the user.

### SUMMARY

The present general inventive concept provides a method to set various photographing configurations according to a user's preference and to enable easy setting of the photographing configurations, and provides a photographing apparatus applying the method.

Additional features and utilities of the present general inventive concept will be set forth in part in the description which follows and, in part, will be obvious from the description, or may be learned by practice of the present general inventive concept.

Exemplary embodiments of the present general inventive concept may be achieved by providing a photographing control method including extracting an image processing scheme useable with image content, and setting an image photographing configuration according to the extracted image processing scheme.

The image processing scheme may be useable with the image content after the image content is generated.

The image content may be generated by a photographing apparatus to photograph an image according to the set image photographing configuration, and the image processing scheme may be useable with the image content by an external apparatus connected to the photographing apparatus.

The extracting may include extracting the image processing scheme useable with the image content from a header of the image content.

The extracting may include extracting an image processing scheme useable with image content which is currently played back, if a user enters a predetermined command during playback of the image content.

The extracting may be performed if one situation of the following is determined to have occurred: a situation in which the image content is played back; a situation in which the image content is received from an external source; and a situation in which a user selects one of stored image content.

The method may further include setting the image photographing configuration according to an image processing scheme selected by a user from image processing schemes applied for each stored image content.

The image processing scheme may include at least one of image filtering and image effect setting.

Exemplary embodiments of the present general inventive concept may be achieved by providing a photographing apparatus including a photographing unit to convert an image of an object for photography into an image signal, a signal processor to perform signal processing on the image signal output from the photographing unit, a codec to compress the image signal processed by the signal processor to generate image content, a storage unit to store the image content generated by the codec, and a controller to control at least one of the photographing unit, the signal processor, the codec and the storage unit. The codec may extract an image processing scheme useable with the image content stored in the storage unit, and the controller may set an image photographing configuration according to the image processing scheme extracted by the codec.

The image processing scheme may be useable with the image content after the image content is generated.

The image content may be generated by the photographing apparatus, and the image processing scheme may be useable with the image content by an external apparatus connected to the photographing apparatus.

The codec may extract the image processing scheme useable with the image content from a header of the image content.

The codec may extract an image processing scheme useable with image content which is currently played back, if a user enters a predetermined command during playback of the image content.

The codec may extract the image processing scheme useable with the image content if one situation of the following is determined to have occurred: a situation in which the image content is played back, a situation in which the image content is received from an external source, and a situation in which a user selects one of stored image content.

The controller may set the image photographing configuration according to an image processing scheme selected by a user from image processing schemes applied for each stored image content.

The image processing scheme may include at least one of image filtering and image effect setting.

Exemplary embodiments of the present general inventive concept may be achieved by providing a computer-readable recoding medium having stored thereon code to control a computing device to perform a method, the method including performing image processing on image content received from a photographing apparatus according to user's editing instructions, recording an image processing scheme on a header of the image content, and transmitting the image content to the photographing apparatus.

Exemplary embodiments of the present general inventive concept further include a method of setting user instructions in an image capturing apparatus including processing image content according to user editing instructions, determining an image processing scheme according to the user editing instructions, recording the image processing scheme on a header of the processed image content, and setting an image photographing configuration according to the recorded image processing scheme.

Exemplary embodiments of the present general inventive concept further include an image production apparatus including a photographing apparatus to generate and transmit image content, and an image processing device to determine and record an image processing scheme on a header of the transmitted image content according to user editing instructions, such that the photographing apparatus sets an image photographing configuration according to the recorded image processing scheme.

### BRIEF DESCRIPTION OF THE DRAWINGS

Exemplary embodiments of the present general inventive concept will become apparent and more readily appreciated from the following description of the embodiments, taken in conjunction with the accompanying drawings in which:

FIG. 1 is a block diagram illustrating a photographing apparatus according to an exemplary embodiment of the present general inventive concept;

FIG. 2 is a flowchart illustrating a photographing control method according to another exemplary embodiment of the present general inventive concept; and

FIG. 3 is a block diagram illustrating in detail the photographing control method illustrated in FIG. 2.

### DETAILED DESCRIPTION OF THE EXEMPLARY EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

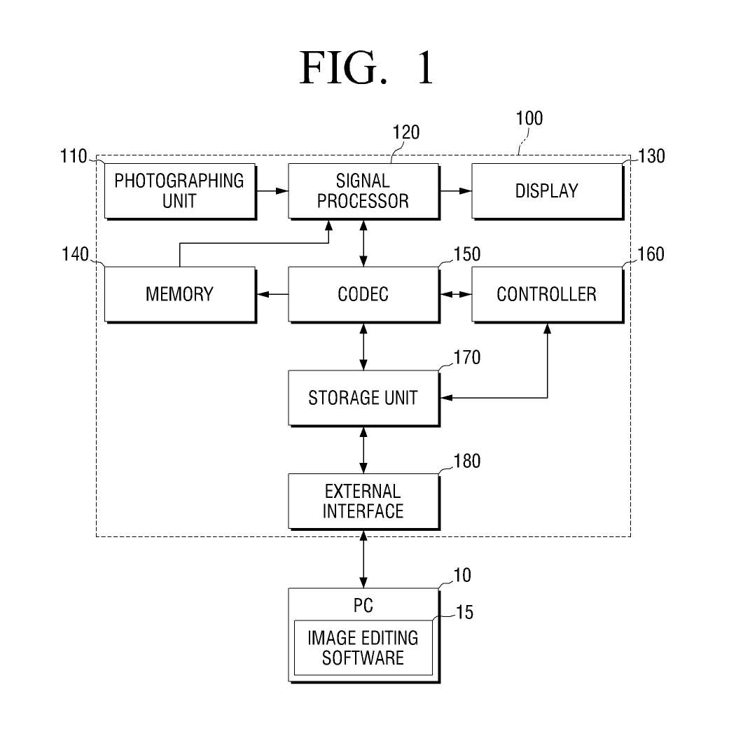

FIG. 1 is a block diagram illustrating a photographing apparatus 100 according to an exemplary embodiment of the present general inventive concept. The photographing apparatus 100 illustrated in FIG. 1 may be implemented as a digital camera or a digital camcorder, or any apparatus capable of performing a photographing function.

As illustrated in FIG. 1, the photographing apparatus 100 includes a photographing unit 110, a signal processor 120, a display 130, a memory 140, a codec 150, a controller 160, a storage unit 170, and an external interface 180.

The photographing unit 110 can convert an image of an object for photography, which is input through a lens and formed on an optical plane of an image pickup device, into an image signal.

The signal processor 120 can perform signal processing on the image signal output from the photographing unit 110. The memory 140 may contain information regarding an image photographing configuration. The signal processor 120 can perform image signal processing according to the information regarding the image photographing configuration stored in the memory 140.

The codec 150 can compress the image signal processed by the signal processor 120, to generate image content. The storage unit 170 can store the image content generated by the codec 150 in a recording medium.

Additionally, the storage unit 170 can read the image content recorded in the recording medium, and can transfer the read image content to the codec 150. After receiving the image content from the storage unit 170, the codec 150 can decompress the received image content, to generate an image signal.

The display 130 can display an image represented by the image signal, which is generated by the photographing unit 110 and processed by the signal processor 120. Additionally, the display 130 can display an image represented by the image content, which is read by the storage unit 170 and decompressed by the codec 150.

The external interface 180 may communicably connect to a personal computer (PC) 10. In this situation, not only may a wire connection scheme such as a universal serial bus (USB) scheme be used to connect the external interface 180 to the PC 10, but also a wireless connection scheme may be used to connect the external interface 180 to the PC 10.

The controller 160 can directly and/or indirectly control the photographing unit 110, the signal processor 120, the display 130, the memory 140, the codec 150, the storage unit 170 and the external interface 180, in order to perform operations according to user commands.

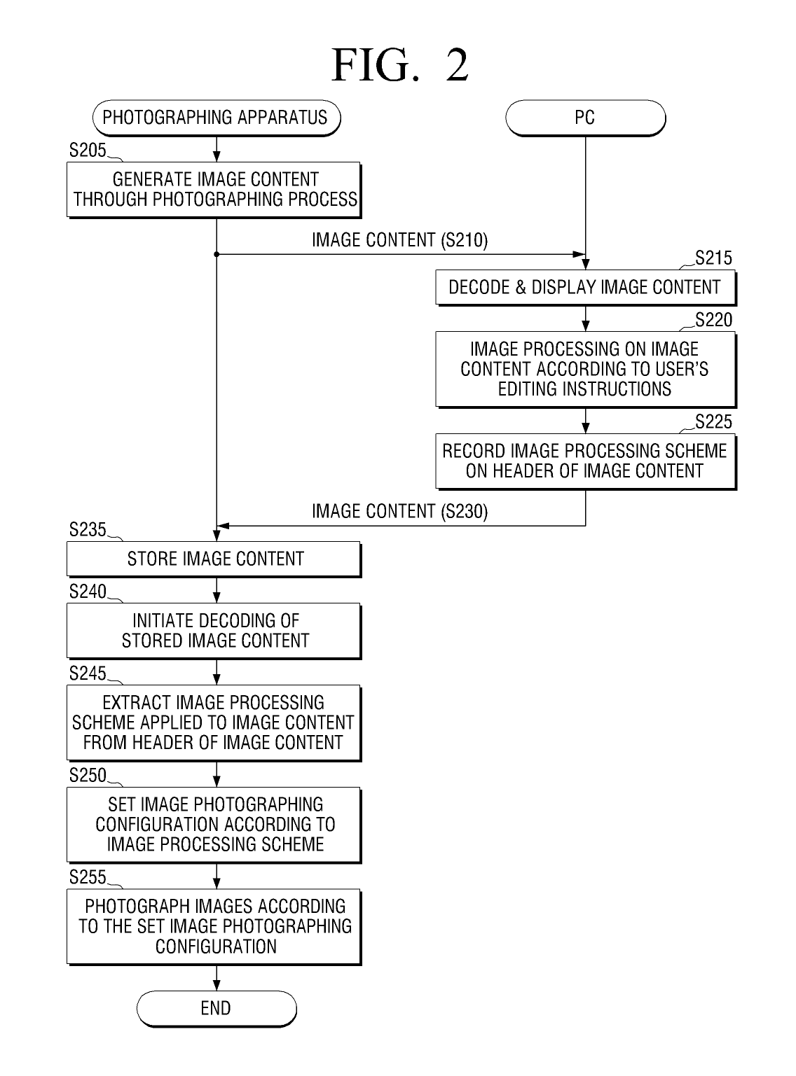

In particular, the controller 160 can set the image photographing configuration of the photographing apparatus 100 according to an image processing scheme useable with image content emitted using image editing software 15 of the PC 10. This process will be described in detail with reference to FIG. 2.

FIG. 2 is a flowchart illustrating a photographing control method according to another exemplary embodiment of the present general inventive concept. As illustrated in FIG. 2, the photographing apparatus 100 generates image content through a photographing process in operation S205.

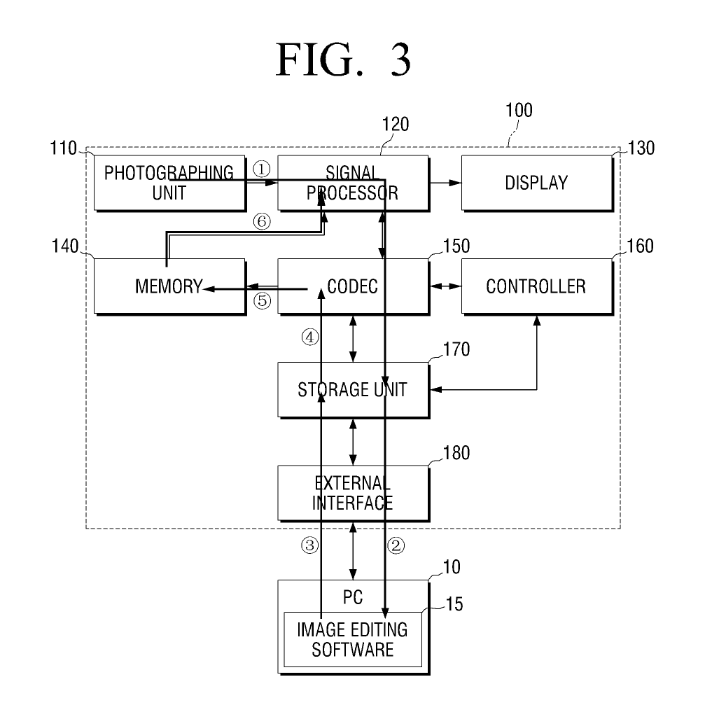

The photographing process in operation S205 is performed, in such a manner that the signal processor 120 may process the image signal generated by the photographing unit 110, the codec 150 may compress the processed image signal and generate image content and the storage unit 170 may store the generated image content. The photographing process is represented by arrow \textcircled{1} in FIG. 3.

The controller 160 may transfer the image content generated in operation S205 to the PC 10 through the external interface 180 in operation S210. Operation S210 may generally be performed when a user enters a command to transmit the image content stored in the storage unit 170 to the PC 10. Additionally, operation S210 is represented by arrow \textcircled{2} in FIG. 3.

The image editing software 15 may be in the PC 10 to decode and decompress the image content output from the controller 160, and display the decompressed image content on a monitor in operation S215.

Additionally, the image editing software 15 may perform image processing on the image content according to user's editing instructions in operation S220. In operation S220, the image processing scheme may be determined according to the user's editing instructions. The image processing scheme may include, for example, image filtering or image effect setting.

Subsequently, the image editing software 15 may record the image processing scheme on a header of the image content, and then compress the image content to store the compressed image content in the PC 10 in operation S225. Operation S225 may be performed when a user finishes editing the image content or when a user enters a command to store the image content.

The PC 10 may transmit the stored image content to the photographing apparatus 100 in operation S230. Operation S230 may generally be performed when a user enters a command to transmit the image content stored in the PC 10 to the photographing apparatus 100. Operation S230 is represented by arrow \textcircled{3} in FIG. 3.

In operation S235, the controller 160 of the photographing apparatus 100 may store in the storage unit 170 the image content received through the external interface 180 from the PC 10 in operation S230.

The codec 150 may initiate decoding of the image content stored in the storage unit 170 in order to decompress the stored image content in operation S240. During operation S240, the codec 150 may generally perform the decoding when a user enters a command to play back the image content stored in the storage unit 170. Operation S240 is represented by arrow \textcircled{4} in FIG. 3.

The display unit 130 may display the image content decoded by the codec 150.

After operation S240, the codec 150 may extract the image processing scheme useable with the image content from the header of the decompressed image content in operation S245. Operation S245 may be performed when a user enters a command to set the photographing configuration in conformity with the image processing scheme useable with the displayed image content while viewing the displayed image content.

In operation S245, the image processing scheme may be extracted from the header of the image content by the CODEC 150, because the image editing software 15 may record the image processing scheme on the header of the image content in operation S225. Additionally, the image processing scheme may contain information regarding the image processing performed in operation S220.

After operation S245, the controller 160 may set the image photographing configuration according to the extracted image processing scheme in operation S250. Accordingly, the controller 160 may control the codec 150 to store the extracted image processing scheme as an image photographing configuration in memory 140. This process is represented by arrow \textcircled{5} in FIG. 3.

Accordingly, the photographing apparatus 100 may photograph images according to the image photographing configuration set in operation S250. In operation S255, the signal processor 120 may process the image signal generated by the photographing unit 110 according to the image photographing configuration stored in the memory 140 in operation S250. This process is represented by arrows \textcircled{1} and \textcircled{6} in FIG. 3.

The process of setting the image photographing configuration of the photographing apparatus 100 according to the image processing scheme useable with the image content edited by the image editing software 15 of the PC 10 has been described in detail with reference to the exemplary embodiments of the present general inventive concept.

While the PC 10 may perform image processing on the image content in the exemplary embodiment of the present general inventive concept, this is merely exemplary for convenience of description. Accordingly, the image processing may be performed by apparatuses other than the PC 10, after image content is generated.

Additionally, the image processing may be performed by any external apparatus regardless of whether or not the external apparatus is connected to the photographing apparatus 100. In addition, the present general inventive concept is also applicable to a situation in which the image processing is performed by the photographing apparatus 100.

Furthermore, although the image content may be generated by the photographing apparatus 100 in the exemplary embodiment of the present general inventive concept, this is merely exemplary for convenience of description. Accordingly, the image content may be generated by apparatuses other than the photographing apparatus 100.

Moreover, the image processing scheme useable with the image content may be recorded on the header of the image content in the exemplary embodiment of the present general inventive concept, but may also be recorded on portions of the image content other than the header.

In addition, the image processing scheme useable with the image content may be extracted when the image content is played back in the exemplary embodiment of the present general inventive concept, but this extracting operation may be modified and performed if necessary. For example, if image content is received from the PC 10, an image processing scheme useable with the image content may be extracted immediately after receiving of the image content. Alternatively, if a user selects one of the image content stored in the storage unit 170, an image processing scheme useable with the selected image content may be extracted.

Additionally, each image processing scheme useable with each image content may be previously stored in the storage unit 170, and a user may select one of the stored image processing scheme, so that the image photographing configuration may be set according to the selected image processing scheme.

While the image filtering and image effect setting are merely examples of the image processing scheme, there is no limitation thereto. Accordingly, the present general inventive concept is also applicable to other image processing schemes.

As described above, according to aspects of the present general inventive concept, it is possible to set the image photographing configuration according to the image processing scheme useable with image content. Therefore, it is possible to easily set various photographing configurations according to a user's preference.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been illustrated and described, it will be appreciated by those skilled in the art that changes may be made in these exemplary embodiments without departing from the principles and spirit of the present general inventive concept, the scope of which is defined in the appended claims and their equivalents.

What is claimed is:

1. A photographing control method comprising:
extracting an image processing scheme useable with image content; and
setting an image photographing configuration according to the extracted image processing scheme.

2. The method according to claim 1, wherein the image processing scheme is useable with the image content after the image content is generated.

3. The method according to claim 2, wherein the image content is generated by a photographing apparatus to photograph an image according to the set image photographing configuration, and
the image processing scheme is useable with the image content by an external apparatus connected to the photographing apparatus.

4. The method according to claim 1, wherein the extracting comprises:
extracting the image processing scheme useable with the image content from a header of the image content.

5. The method according to claim 1, wherein the extracting comprises:
extracting an image processing scheme useable with image content which is currently played back, if a user enters a predetermined command during playback of the image content.

6. The method according to claim 1, wherein the extracting is performed if one of the following situations is determined to have occurred:
a situation in which the image content is played back;
a situation in which the image content is received from an external source; and
a situation in which a user selects one of stored image content.

7. The method according to claim 1, further comprising:
setting the image photographing configuration according to an image processing scheme selected by a user from image processing schemes applied for each stored image content.

8. The method according to claim 1, wherein the image processing scheme comprises:
at least one of image filtering and image effect setting.

9. A photographing apparatus comprising:
a photographing unit to convert an image of an object for photography into an image signal;
a signal processor to perform signal processing on the image signal output from the photographing unit;
a codec to compress the image signal processed by the signal processor to generate image content;
a storage unit to store the image content generated by the codec; and
a controller to control at least one of the photographing unit, the signal processor, the codec and the storage unit,
wherein the codec extracts an image processing scheme useable with the image content stored in the storage unit, and
the controller sets an image photographing configuration according to the image processing scheme extracted by the codec.

10. The photographing apparatus according to claim 9, wherein the image processing scheme is useable with the image content after the image content is generated.

11. The photographing apparatus according to claim 10, wherein the image content is generated by the photographing apparatus, and
the image processing scheme is useable with the image content by an external apparatus connected to the photographing apparatus.

12. The photographing apparatus according to claim 9, wherein the codec extracts the image processing scheme useable with the image content from a header of the image content.

13. The photographing apparatus according to claim 9, wherein the codec extracts an image processing scheme useable with image content which is currently played back, if a user enters a predetermined command during playback of the image content.

14. The photographing apparatus according to claim 9, wherein the CODEC extracts the image processing scheme useable with the image content if one of the following situations is determined to have occurred:
a situation in which the image content is played back;
a situation in which the image content is received from an external source; and
a situation in which a user selects one of stored image content.

15. The photographing apparatus according to claim 9, wherein the controller sets the image photographing configuration according to an image processing scheme selected by a user from image processing schemes applied for each stored image content.

16. The photographing apparatus according to claim 9, wherein the image processing scheme comprises:
at least one of image filtering and image effect setting.

17. A computer-readable recoding medium having stored thereon code to control a computing device to perform a method, the method comprising:
performing image processing on image content received from a photographing apparatus according to user's editing instructions;
recording an image processing scheme on a header of the image content; and
transmitting the image content to the photographing apparatus.

18. A method of setting user instructions in an image capturing apparatus comprising:
processing image content according to user editing instructions;
determining an image processing scheme according to the user editing instructions;
recording the image processing scheme on a header of the processed image content; and
setting an image photographing configuration according to the recorded image processing scheme.

19. The method of claim 18, wherein processing image content according to user editing instructions comprises:
capturing and converting an image into an image signal;
processing and compressing the image signal to generate image content; and
storing the image content.

20. The method of claim 19, wherein setting an image photographing configuration according to the recorded image processing scheme comprises:
decompressing the processed image content; and
extracting the image processing scheme from the header of the processed image content.
